(19) United States
(12) Patent Application Publication
(10) Pub. No.: US 2005/0215279 A1
(43) Pub. Date: Sep. 29, 2005

(54) SERVICE FLOW MANAGEMENT METHOD OF MOBILE SUBSCRIBER STATION IN A MOBILE BROADBAND WIRELESS ACCESS SYSTEM

(75) Inventors: Jae-Jeong Shim, Seoul (KR); Bong-Gee Song, Gyeonggi-do (KR); Kwang-Seop Eom, Gyeonggi-do (KR); Seung-Eun Hong, Gyeonggi-do (KR); Yeong-Moon Son, Gyeonggi-do (KR); So-Hyun Kim, Gyeonggi-do (KR); Hyon-Goo Kang, Gyeonggi-do (KR); Tae-Won Kim, Gyeonggi-do (KR); Geun-Hwi Lim, Gyeonggi-do (KR); Jung-Shin Park, Seoul (KR); Seung-Il Yoon, Gyeonggi-do (KR); Hong-Sung Chang, Gyeonggi-do (KR); Yong Chang, Gyeonggi-do (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/073,114

(22) Filed: Mar. 4, 2005

(30) Foreign Application Priority Data
Mar. 5, 2004 (KR) 15207/2004

(51) Int. Cl. H04Q 7/20

(52) U.S. Cl. 455/550.1

(57) ABSTRACT

A method for managing a service flow of a mobile subscriber station (MSS) in a serving base station (BS) for a mobile communication system including the serving BS in communication with the MSS through a wireless access channel, and at least one active BS included in an active BS set of the MSS. Upon receiving a service flow management request from the MSS, the serving BS updates a service flow with the MSS, and transmits the updated service flow to the active BS using a predetermined message. Upon receiving a response message for the updated service flow from the active BS, the serving BS transmits service flow information of each active BS included in the response message to the MSS.

### PRIORITY

This application claims priority under 35 U.S.C. § 119 to an application entitled “Service Flow Management Method of Mobile Subscriber Station Having Active BS Set in a Mobile Broadband Wireless Access System” filed in the Korean Intellectual Property Office on Mar. 5, 2004 and assigned Serial No. 2004-15207, the contents of which are incorporated herein by reference.

### BACKGROUND OF THE INVENTION

1. Field of the Invention

The present invention relates to a service flow offering method in a mobile communication system, and more particularly, to a method for changing service flow by a mobile subscriber station (MSS) or a base station (BS).

2. Description of the Related Art

Referring to FIGS. 1 to 3, a procedure for changing an existing service flow in an IEEE 802.16e system according to the prior art is described.

A service flow change procedure, that may include adding or deleting service, is a procedure defined between one MSS and one BS. FIG. 1 illustrates a Dynamic Service Addition (DSA) procedure for adding a new service flow by an MSS 10.

Referring to FIG. 1, an MSS 10 transmits a Dynamic Service Addition Request (“DSA-REQ”) message with service parameters for a service flow to a BS 20 to add the corresponding service flow in step 11. An exemplary format of the “DSA-REQ” message is illustrated in FIG. 2.

Upon receiving the “DSA-REQ” message, the BS 20 transmits a DSx Received (“DSX-RVD”) message to the MSS 10 in step 12, to inform the MSS 10 that it has received and is processing the “DSA-REQ” message. An exemplary format of the “DSX-RVD” message is illustrated in FIG. 3. The “DSX-RVD” message is a message that a BS transmits to an MSS in response to a Dynamic Service Addition (DSA) message, a Dynamic Service Change (DSC) message, and a Dynamic Service Deletion (DSD). After adding the service flow requested by the MSS 10, the BS 20 transmits the result to the MSS 10 through a Dynamic Service Addition Response (“DSA-RSP”) message in step 13.

An exemplary format of the “DSA-RSP” message is illustrated in FIG. 4. The “DSA-RSP” message includes a confirmation code (CC) of the “DSA-REQ” message and parameters for the requested new service flow. The parameters are illustrated in FIG. 5.

Unless all of the parameters requested in the “DSA-REQ” message are not satisfied, the “DSA-RSP” message includes failure fields called “Service Flow Error Set.” In step 14, the MSS 10 transmits a Dynamic Service Addition Acknowledgement (“DSA-ACK”) message to the BS 20 to inform the BS 20 that it has received the “DSA-RSP” message. An exemplary format of the “DSA-ACK” message is illustrated in FIG. 6.

FIG. 7 illustrates a Dynamic Service Change (DSC) procedure for changing an existing service flow, which may be used to change service parameters for an existing service flow.

Referring to FIG. 7, an MSS 30 transmits service flow parameters with new traffic characteristics, or scheduling requirements of a service flow to be changed, to a BS 40 through a Dynamic Service Change Request (“DSC-REQ”) message in step 31. An exemplary format of the “DSC-REQ” message is illustrated in FIG. 8.

Upon receiving the “DSC-REQ” message, the BS 40 transmits a “DSX-RVD” message to the MSS 30 in step 32, to inform the MSS 30 that it has received, and is processing the “DSC-REQ” message. After processing changes for the service flow requested in the “DSC-REQ”, the BS 40 transmits a Dynamic Service Change Response (“DSC-RSP”) message with a confirmation code, a Connection ID (CID) to be newly allocated, and a parameter, to the MSS 30 in step 33. An exemplary format of the “DSC-RSP” message is illustrated in FIG. 9.

Lastly, the MSS 30 transmits a Dynamic Service Change Acknowledgement (“DSC-ACK”) message to the BS 40 to inform the BS 40 that it has received the “DSC-RSP” message. An exemplary format of the DSC-ACK message is illustrated in FIG. 10.

FIG. 11 is a signaling diagram illustrating a Dynamic Service Deletion (DSD) procedure for deleting an existing service flow of an MSS. Referring to FIG. 11, an MSS 50 transmits a Dynamic Service Deletion Request (“DSD-REQ”) message with a Service Flow ID to delete, to a BS 60 in step 51. An exemplary format of the DSD-REQ message is illustrated in FIG. 12.

In response, the BS 60 deletes the corresponding service flow, and transmits a Dynamic Service Deletion Response (“DSD-RSP”) message with a confirmation code and a deleted service flow ID to the MSS 50 in step 52. An exemplary format of the DSD-RSP message is illustrated in FIG. 13.

As described above, in the existing IEEE 802.16e system, because the MSS accesses only one serving BS (S-BS) service flow is only processed in the S-BS when the MSS changes service flow.

Recently, an active BS set concept disclosed in Korean patent application No. 2004-15040, filed by the applicant, entitled “Method for Supporting Active BS Set for Improving Handover Performance in a Mobile Broadband Wireless Access System and Signaling Procedure therefor,” has been introduced.

The active BS set refers to a set of BSs that are not required to perform the remaining procedures except for a ranging process upon handover of an MSS that includes providing the MSS with a wireless access channel for data transmission and reception via an S-BS.

The ranging process is where an MSS performs timing correction and power correction with a BS. One MSS can have several service flows, and the service flow is a unit flow that is serviced with a specific Quality of Service (QoS) and is identified by a service flow identifier (SFID).

Accordingly, there is a demand for technology in which all active BSs of an MSS can process a service flow requested by the MSS.

### SUMMARY OF THE INVENTION

It is, therefore, an object of the present invention to provide a method for enabling all active BSs of an MSS to process a service flow requested by the MSS.

It is another object of the present invention to provide a method in which upon an MSS's processing request for a particular service flow, the MSS can perform only a ranging process and immediately access any active BS included in an active BS set in course of a network re-entry procedure, thereby enabling fast handover.

It is further another object of the present invention to provide a method in which upon addition or any change of a particular service flow by two or more active BSs, the active BSs efficiently transmit service flow-related parameters to an MSS via an S-BS with duplicate information omitted.

In accordance with one aspect of the present invention, there is provided a method for managing a service flow of a mobile subscriber station (MSS) in a serving base station (BS) for a mobile communication system including the serving BS in communication with the MSS through a wireless access channel, and at least one active BS included in an active BS set of the MSS. The method includes, upon receiving a service flow management request from the MSS, updating a service flow with the MSS; transmitting the updated service flow to the active BS using a predetermined message; and upon receiving a response message for the updated service flow from the active BS, transmitting service flow information of each active BS included in the response message to the MSS.

In accordance with another aspect of the present invention, there is provided a method for managing a service flow in a mobile subscriber station (MSS) for a mobile communication system including the MSS in communication with a serving base station (BS) though a wireless access channel, and at least one active BS included in an active BS set of the MSS. The method includes, upon occurrence of a service flow management request, transmitting a predetermined service flow update message to the serving BS; and receiving a response to the service flow update message from the serving BS, and updating a service flow based on the received response.

In accordance with further aspects of the present invention, there is provided a method for adding a service flow of a mobile subscriber station (MSS) in a serving base station (BS) for a mobile communication system including the serving BS in communication with the MSS through a wireless access channel, and at least one active BS included in an active BS set of the MSS. The method includes, upon receiving a service flow addition request from the MSS, adding a service flow identifier (ID); transmitting the added service flow ID to the active BS using a predetermined message; and upon receiving a response message with the added service flow ID from the active BS, allocating a new connection ID to the MSS.

In accordance with still further other aspects of the present invention, there is provided a method for changing a service flow of a mobile subscriber station (MSS) in a serving base station (BS) for a mobile communication system including the serving BS in communication with the MSS through a wireless access channel, and at least one active BS included in an active BS set of the MSS. The method includes, upon receiving a service flow change request from the MSS, changing a service flow identifier (ID); transmitting the changed service flow ID to the active BS using a predetermined message; and upon receiving a response message with the changed service flow ID from the active BS, transmitting information on the changed service flow to the MSS.

In accordance with yet still further other aspects of the present invention, there is provided a method for deleting a service flow of a mobile subscriber station (MSS) in a serving base station (BS) for a mobile communication system including the serving BS in communication with the MSS through a wireless access channel, and at least one active BS included in an active BS set of the MSS. The method includes, upon receiving a service flow deletion request from the MSS, deleting a service flow identifier (ID); transmitting the deleted service flow ID to the active BS using a predetermined message; and informing the MSS of deletion of a connection ID.

In accordance with still further aspects of the present invention, there is provided a method for managing a service flow of a mobile subscriber station (MSS) in a serving base station (BS) for a mobile communication system including the serving BS in communication with the MSS through a wireless access channel, and at least one active BS included in an active BS set of the MSS. The method includes upon receiving a service flow management request from the MSS, allocating a connection identifier (ID) to the MSS according to the service flow; and transmitting to the MSS the allocated connection ID and a connection ID allocated to the MSS according to the service flow in the at least one active BS exclusive of the serving BS.

In accordance with still further other aspects of the present invention, there is provided a method for managing a service flow in a mobile subscriber station (MSS) for a mobile communication system including a serving base station (BS) in communication with the MSS through a wireless access channel, and at least one active BS included in an active BS set of the MSS, with the exception of the serving BS. The method includes, upon occurrence of a service flow management request, transmitting a predetermined service flow update request message to the serving BS; and receiving a response message for the service flow update request message from the serving BS, and updating service flows of active BSs included in the active BS set.

### BRIEF DESCRIPTION OF THE DRAWINGS

The above and other objects, features and advantages of the present invention will become more apparent from the following detailed description when taken in conjunction with the accompanying drawings in which:

FIG. 1 is a signaling diagram illustrating a dynamic service flow addition method in a mobile broadband wireless access system according to the prior art;

FIG. 2 is diagram illustrating an example of a format of a DSA-REQ message;

FIG. 3 is a diagram illustrating an example of a format of a DSX-RVD message;

FIG. 4 is a diagram illustrating an example of a format of a DSA-RSP message;

FIG. 5 is a diagram illustrating a format of Confirmation code;

FIG. 6 is a diagram illustrating an example of a format of a DSA-ACK message;

FIG. 7 is a signaling diagram illustrating a dynamic service flow change procedure in an IEEE 802.16/802.16e system according to the prior art;

FIG. 8 is a diagram illustrating an example of a format of a DSC-REQ message;

FIG. 9 is a diagram illustrating an example of a format of a DSC-RSP message;

FIG. 10 is a diagram illustrating an example of a format of a DSC-ACK message;

FIG. 11 is a signaling diagram illustrating a dynamic service flow deletion procedure in an IEEE 802.16/802.16e system according to the prior art;

FIG. 12 is a diagram illustrating an example of a format for a DSD-REQ message;

FIG. 13 is a diagram illustrating an example of a format of a DSD-RSP message;

FIG. 14 is a signaling diagram illustrating a dynamic service flow addition procedure in an IEEE 802.16/802.16e system according to an embodiment of the present invention;

FIG. 15 is a diagram illustrating an example of a format of an I-am-host-of message according to an embodiment of the present invention;

FIG. 16 is a diagram illustrating an example of a format of an MSS-info-request message according to an embodiment of the present invention;

FIG. 17 is a diagram illustrating an example of a format of an MSS-info-response message according to an embodiment of the present invention;

FIG. 18 is a diagram illustrating an example of a format of an MSS-info-confirm message newly defined according to an embodiment of the present invention for service flow management in an active BS set;

FIG. 19 is a diagram illustrating an example of a format of a DSA-RSP message modified in the present invention for service flow management in an active BS set;

FIG. 20 is a signaling diagram illustrating a dynamic service flow addition procedure in an IEEE 802.16/802.16e system according to an alternative embodiment of the present invention;

FIG. 21 is a signaling diagram illustrating a dynamic service flow change procedure in an IEEE 802.16/802.16e system according to a further alternative embodiment of the present invention;

FIG. 22 is a diagram illustrating an example of a format of a DSC-RSP message modified in an embodiment of the present invention for service flow management in an active BS set;

FIG. 23 is a signaling diagram illustrating a dynamic service flow change procedure in an IEEE 802.16/802.16e system according to another alternative embodiment of the present invention;

FIG. 24 is a signaling diagram illustrating a dynamic service flow deletion procedure in an IEEE 802.16/802.16e system according to an embodiment of the present invention;

FIG. 25 is a flowchart illustrating an operation of an MSS in the procedure of FIG. 14 according to an embodiment of the present invention; and

FIGS. 26A and 26B are flowcharts illustrating an operation of an S-BS in the procedure of FIG. 14 according to an embodiment of the present invention.

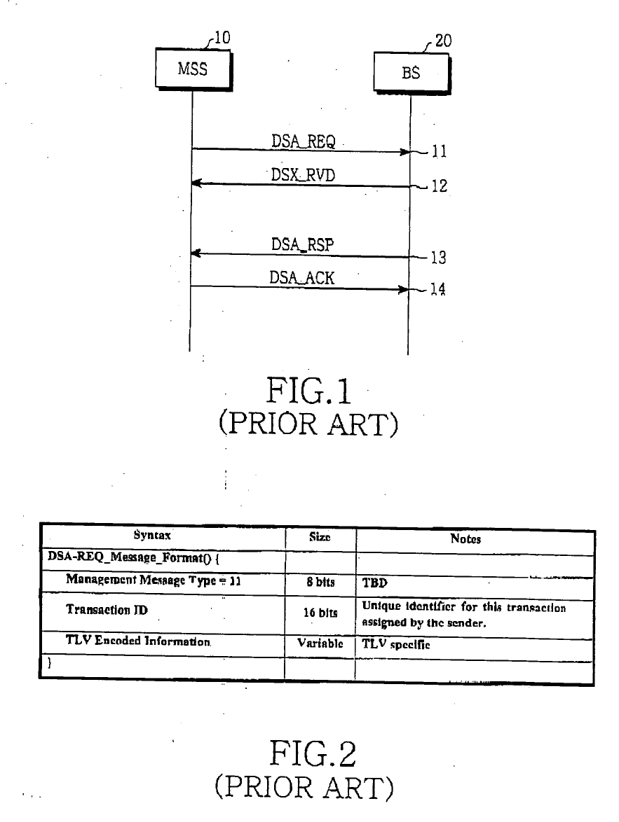

### DETAILED DESCRIPTION OF THE PREFERRED EMBODIMENT

Several preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention presents a function and procedure for simultaneously changing a service flow in all BSs included in an active BS set of an MSS, and a corresponding message format. The terms “addition,” “change,” and “deletion” of service as used herein refers to an “update” of service. “Active BS set” refers to a set of BSs not required to perform the procedures other than a ranging process for network re-entry and handover of an MSS, including a Serving BS (S-BS).

The present invention includes a method for managing a service flow with the following procedures:
(1) a dynamic service flow addition procedure for an MSS with two or more active BSs in an IEEE 802.16e system,
(2) a dynamic service flow change procedure for an MSS with two or more active BSs in an IEEE 802.16e system, and
(3) a dynamic service flow deletion procedure for an MSS with two or more active BSs in an IEEE 802.16e system.

A service flow management method for an MSS supporting an active BS set according to an embodiment of the present invention will now be described, focusing on the above-listed procedures.

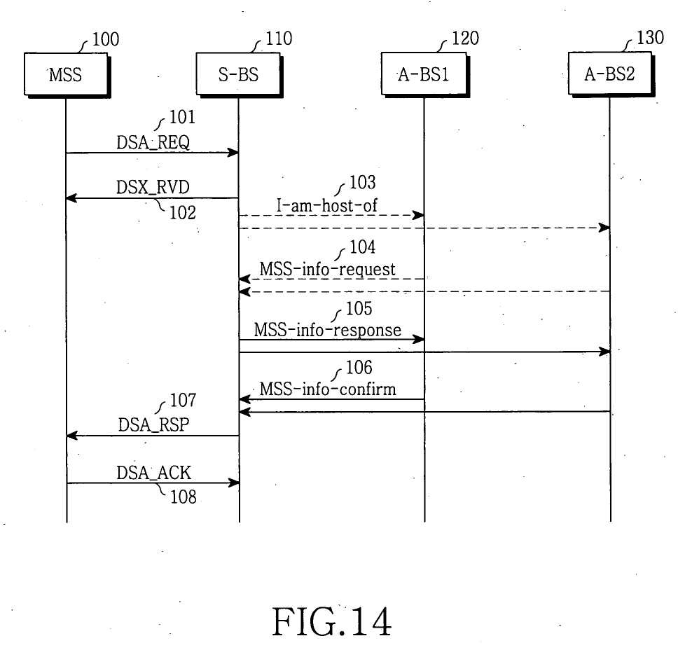

FIG. 14 is a signaling diagram in which an MSS having an active BS set including three active BSs adds a new service flow. Referring to FIG. 14, an MSS 100 with three active BSs 110, 120 and 130 transmits a “DSA-REQ” message to an S-BS 110 for addition of a new service flow in step 101. The conventional message of FIG. 2, defined in IEEE 802.16REVd_D3-2004, may be used for the “DSA-REQ” message.

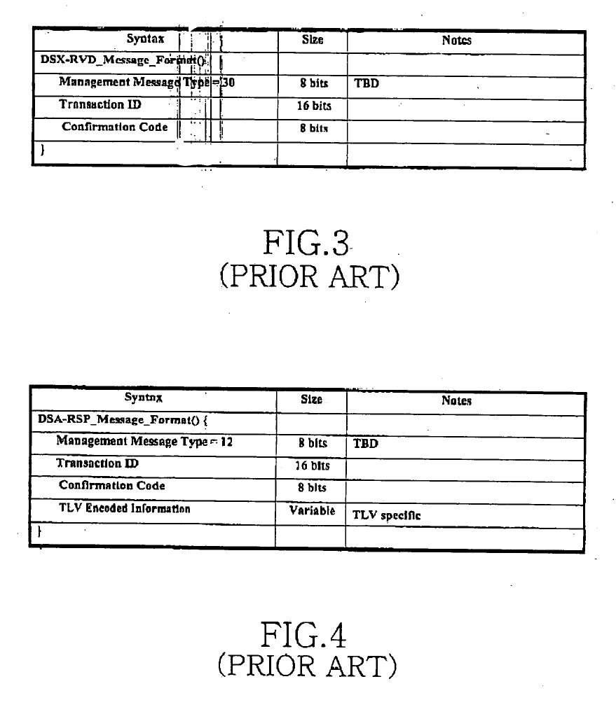

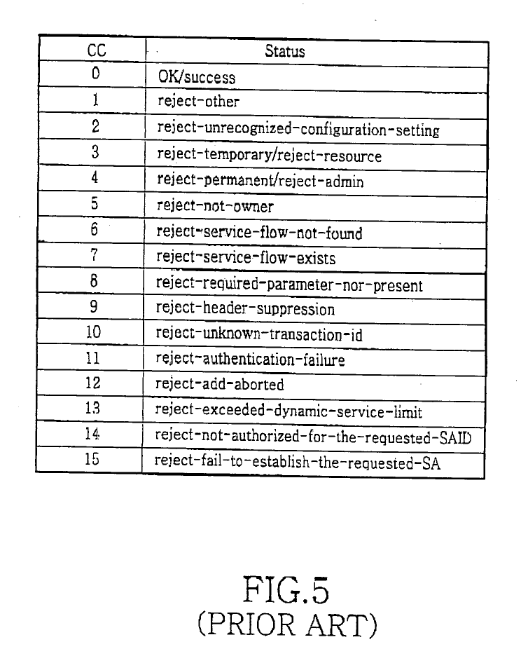

The MSS 100 and the S-BS 110 know that the MSS 100 has three active BSs. In addition, the MSS 100 knows that the three active BSs include an S-BS 110, a first active BS (A-BS1) 120 and a second active BS (A-BS2) 130. Upon receiving the “DSA-REQ” message, the S-BS 110 transmits the “DSX-RVD” message of FIG. 3 to the MSS 100 in step 102, to inform the MSS 100 that it has received, and is processing, the “DSA-REQ” message.

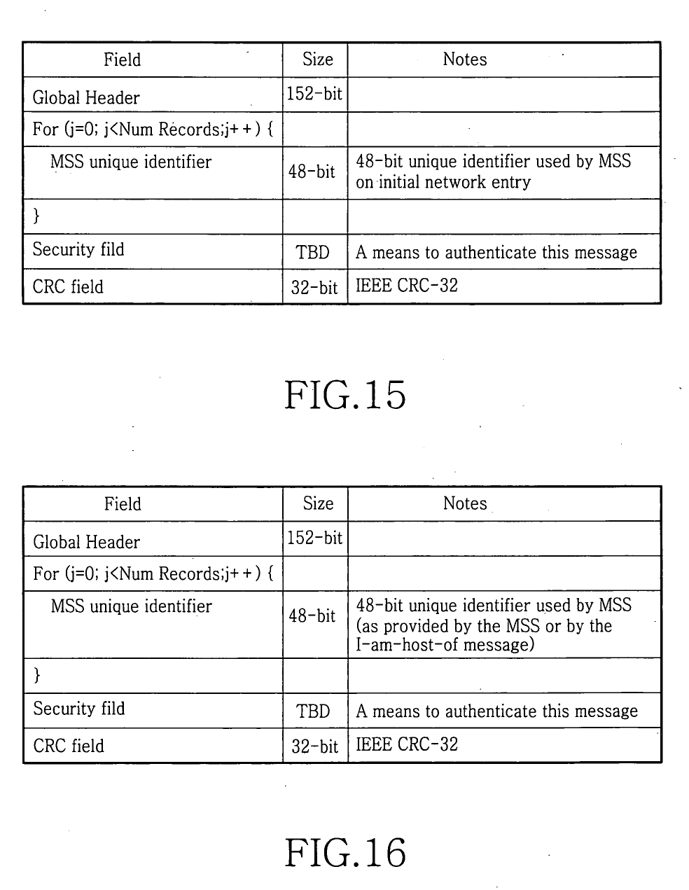

Thereafter, in step 103, the S-BS 110 transmits an “I-am-host-of” message to the remaining active BSs of the A-BS1 120 and the A-BS2 130, indicating that it is a host of the MSS 100,. An exemplary format of the “I-am-host-of” message is illustrated in FIG. 15.

Referring to FIG. 15, the “I-am-host-of” message includes an MSS unique identifier to indicate that the MSS 100 is communicating with the S-BS 110. Upon receipt of the “I-am-host-of” message from the S-BS 110, the A-BS1 120 and the A-BS2 130 check the MSS unique identifier in the “I-am-host-of” message. Because the A-BS1 120 and the A-BS2 130 are active BSs of the MSS 100, they individually transmit an MSS-info-request message to the S-BS 110 in step 104 to request information on the corresponding MSS 100.

An exemplary format of the “MSS-info-request message” is illustrated in FIG. 16. Referring to FIG. 16, the MSS-info-request message includes one or more MSS unique identifiers.

Both of steps 103 and 104, represented by dotted lines in FIG. 14, are optional and may be omitted. In this case, an “MSS-info-response” message transmitted in the next step 105 is transmitted without the MSS-info-request message.

Upon receiving the “MSS-info-request” message, the S-BS 110 transmits an “MSS-info-response” message to the A-BS1 120 and the A-BS2 130, which have transmitted the “MSS-info-request” message, in step 105.

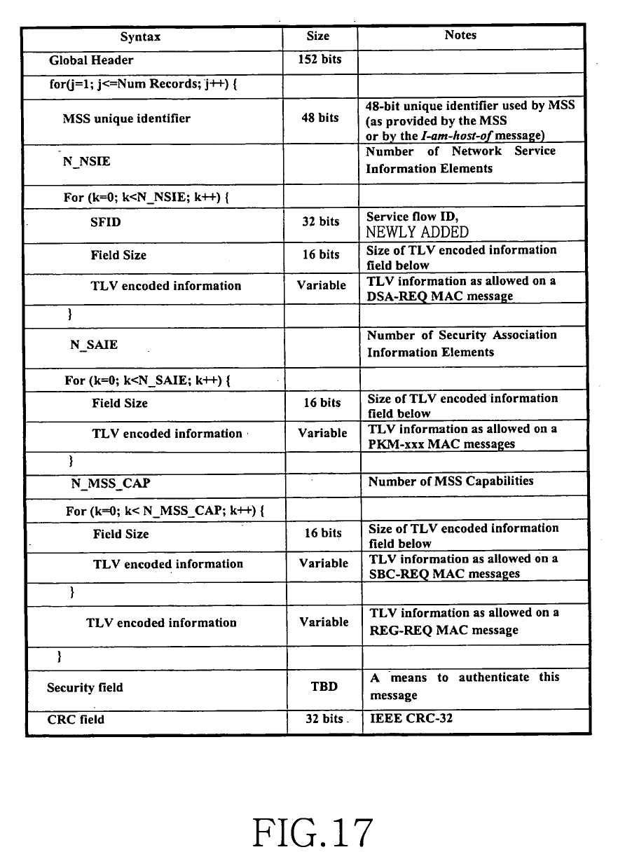

An exemplary format of the MSS-info-response message is illustrated in FIG. 17. Referring to FIG. 17, the “MSS-info-response” message includes a service flow ID (“SFID”) allocated to the current MSS and TLV values of a general DSA-REQ message. PKM, SBC and REG information of the “MSS-info-response” message can be omitted. Herein, PKM information includes authentication-related information of an MSS, SBC information includes capability-related information of an MSS, and REG information includes MSS information such as MAC (Medium Access Control) version and vendor ID the “SFID” ensures the same SFID for each service flow when the MSS 100 is handed over to other active BSs, except the S-BS 110. The active BSs have the same SFID and different connection IDs (CIDs) for their connections set up to the MSS.

Upon receiving the “MSS-info-response” message, the A-BS 1 120 and the A-BS2 130 check the number of network service information elements of the MSS and their corresponding TLV values, included in the MSS-info-response message. The TLV values refer to parameter values including Type, Length and Value. If the checked values are different from the values that the A-BS1 120 and the A-BS2 130 have for the MSS, the A-BS1 120 and the A-BS2 130 manage a service flow appropriate for the MSS 100. In particular, where service flow is added as shown in FIG. 14, upon detecting an increase in number of network service information elements, the A-BS1 120 and the A-BS2 130 add one service flow for the MSS 100 based on the corresponding TLV values, and then transmits the result to the S-BS 110 using an “MSS-info-confirm” message in step 106.

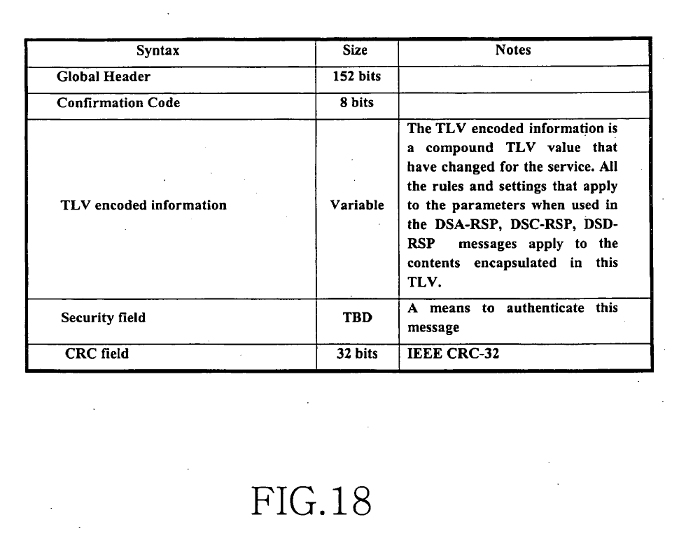

An exemplary format of the “MSS-info-confirm message” is illustrated in FIG. 18. The “MSS-info-confirm message” is newly defined in the present invention and used to transmit the service flow processing result in the active BSs 120 and 130 to the S-BS 110. The message may include confirmation codes and TLV values included in DSA-RSP, DSC-RSP and DSD-RSP messages.

In FIG. 14, an active BS that cannot normally perform service flow addition by step 105 should be deleted from an active BS set of a corresponding MSS. Upon receiving the “MSS-info-confirm” message, the S-BS 110 transmits service flow information, such as SFID and CID added in the active BS to the MSS 100, using a “DSA-RSP” message in step 107. In this case, the “DSA-RSP” message includes information on both the A-BS1 120 and the A-BS2 130.

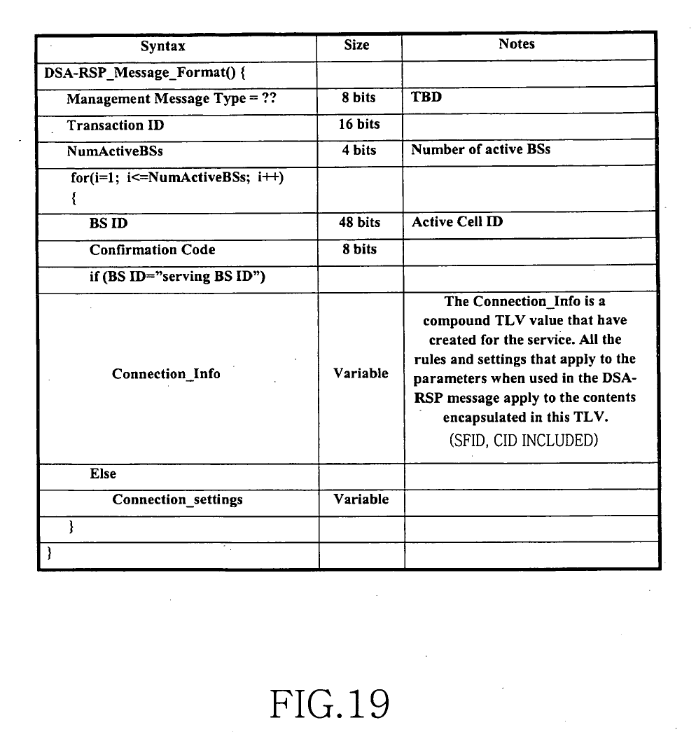

In a preferred embodiment of the present invention, an exemplary format of the “DSA-RSP message” is modified as shown in FIG. 19. Referring to FIG. 19, the “DSA-RSP” message includes service flow-related information from all active BSs. As a result, the message size can increase considerably in proportion to the number of active BSs. Where a dedicated channel for transmitting signaling information is not defined, and signaling messages are transmitted using a traffic channel—like the IEEE 802.16 system—if the size of a signaling message, such as the DSA-RSP message increases, it is difficult to transmit or receive messages in a stable manner and within an appropriate delay.

To solve this problem, the present invention defines a Connection_settings field. The Connection_settings field reduces the size of a Connection_Info field for each active BS that should be transmitted to the MSS 100 in a DSA-RSP message when dynamic service flow addition is performed in the active BS set. This field includes different field values, excluding the same fields as Connection_Info allocated in the S-BS 110—for example, SFID and Service Class Name—when Connection_Info of the remaining active BSs, except the S-BS 110, is transmitted to the MSS 100. In this manner, it is possible to omit or reduce the considerable number of Connection_Info fields in the remaining active BSs.

Formats of the DSA-RSP/DSC-RSP messages using the Connection_settings field are based on the assumption that in a process of adding the same service flow for the same MSS, even though each active BS separately performs a service flow addition procedure, the Connection_Info should be substantially similar.

The Connection_settings field is included in the DSA-RSP/DSC-RSP messages when an MSS having two or more active BSs transmits DSA-REQ/DSC-REQ messages, and can also be used when a new active BS is added to the active BS set.

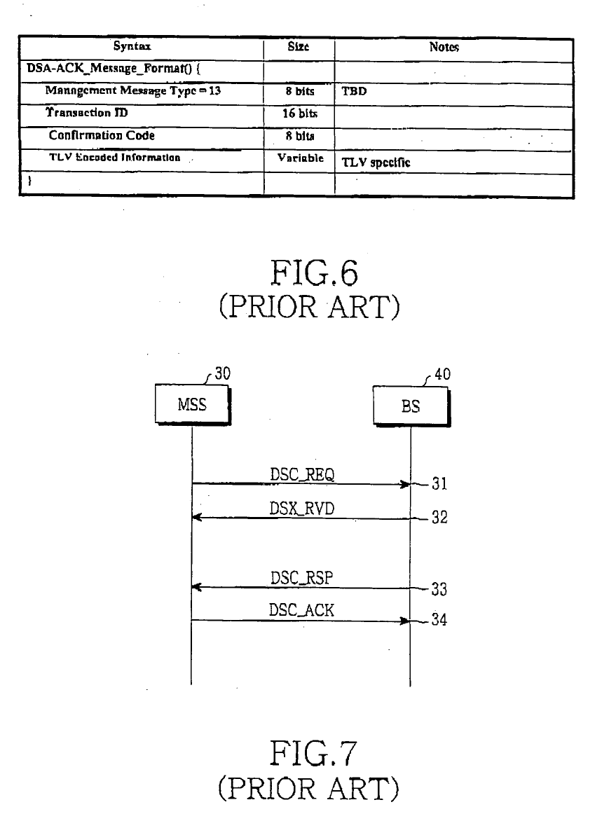

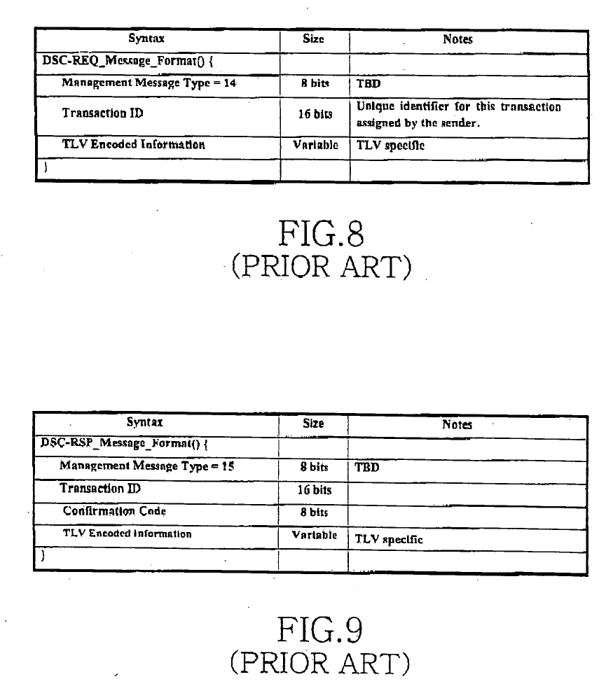

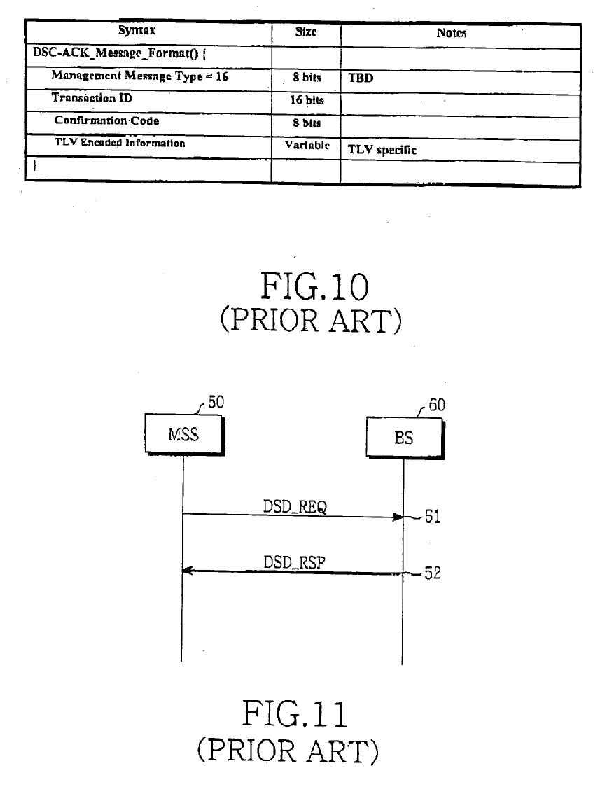

Finally, upon receiving the “DSA-RSP” message, the MSS 100 transmits a “DSA-ACK” message, like the one of FIG. 6, to the S-BS 110 in step 108, completing MSS's service flow addition for all active BSs.

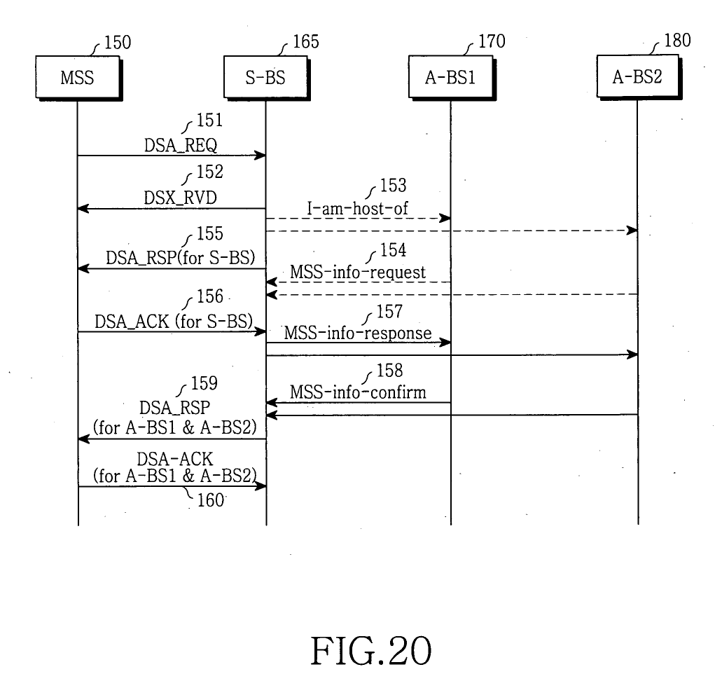

FIG. 20 is a signaling diagram in which an MSS having an active BS set, including three active BSs, adds an existing service flow according to an embodiment of the present invention.

One difference between the procedures illustrated in FIGS. 20 and 14 is that the procedure illustrated in FIG. 20 transmits a processing result of an S-BS 165 by a DSA-REQ message from an MSS 150 to the S-BS 165 in advance of processing results of the remaining active BSs in step 155. This prevents delays caused when an MSS with two or more active BSs receives a DSA-RSP message in response to its DSA-REQ message, from exceeding the delay caused when an MSS having one S-BS receives a DSA-RSP message in response to its DSA-REQ message. In FIG. 20, “DSA-RSP” and “DSA-ACK” messages for the A-BS1 170 and the A-BS2 180 may be transmitted individually to the A-BS1 170 and the A-BS2 180.

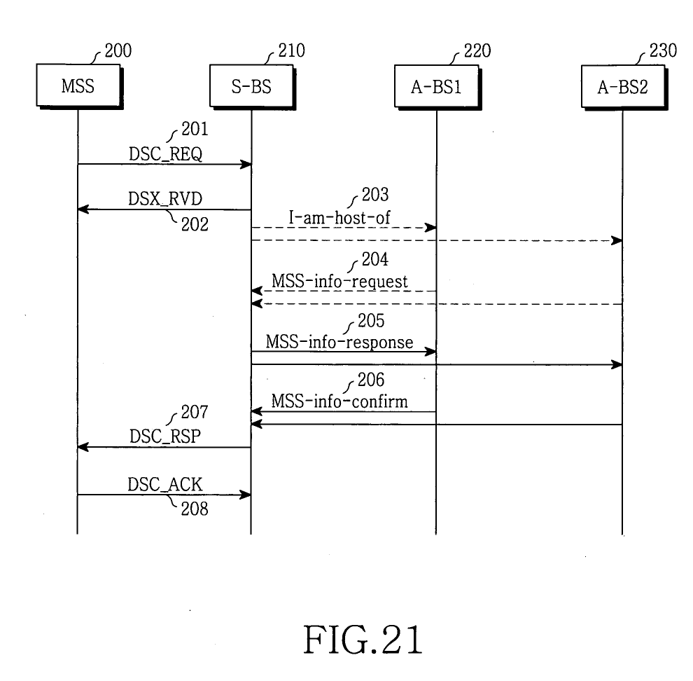

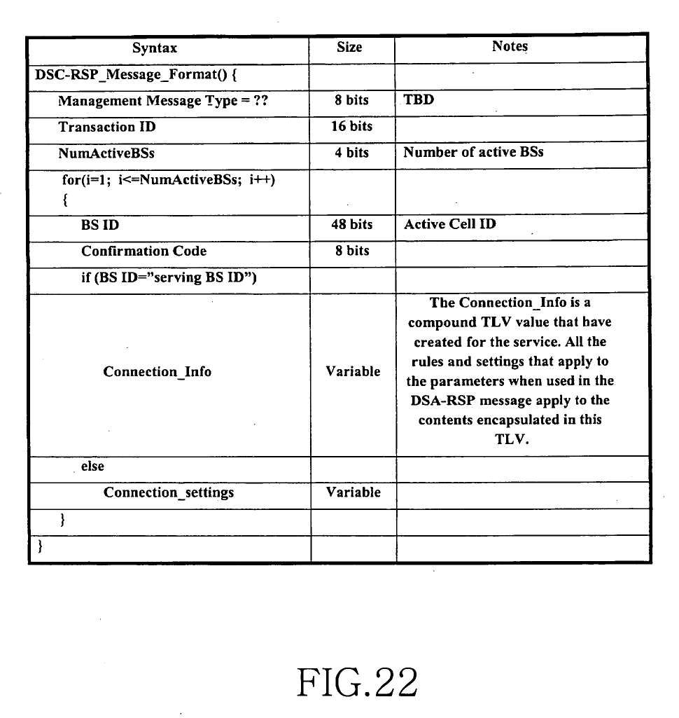

FIG. 21 is a signaling diagram for changing an existing service flow according to an embodiment of the present invention when an MSS has a active BS set with three active BSs. The service flow change procedure of FIG. 21 is similar to the service flow addition procedure of FIG. 14 except that an MSS 200 transmits a “DSC-REQ” message with new traffic characteristics or scheduling requirements of a service flow to be changed, instead of the DSA-REQ message. And, in the next step, an S-BS 210 transmits processing results therefor in active BSs 210, 220 and 230 to the MSS 200 using the DSC-RSP message illustrated in FIG. 22.

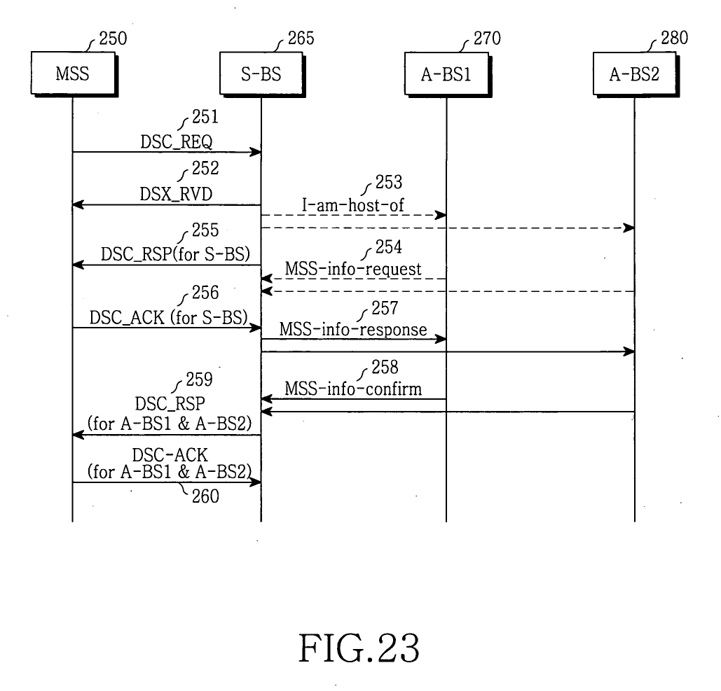

FIG. 23 is a signaling diagram for changing an existing service flow according to an alternative embodiment of the present invention. Because the procedure of FIG. 23 is similar to FIG. 20, a detailed description thereof is omitted.

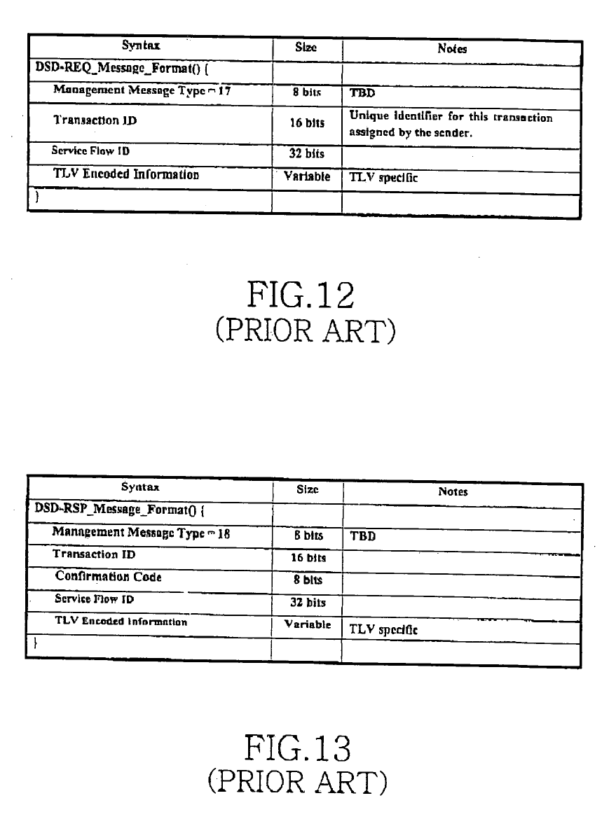

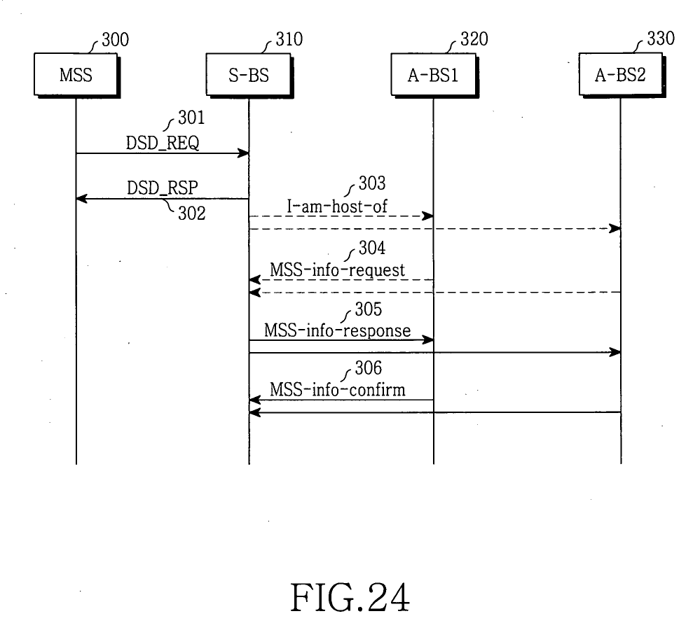

FIG. 24 is a signaling diagram for deleting an existing service flow according to an embodiment of the present invention. Referring to FIG. 24, an MSS 300 having three active BSs 310, 320 and 330 transmits a “DSD-REQ” message to an S-BS 310 to delete an existing service flow in step 310. The conventional message of FIG. 12, defined in IEEE 802.16REVd_D3-2004, may be used for the “DSD-REQ” message. The MSS 300 and the S-BS 310 know that the MSS 300 has three active BSs including an S-BS 310, an A-BS1 320 and an A-BS2 330.

Upon receiving the “DSD-REQ” message, the S-BS 310 deletes the corresponding service flow and transmits a “DSD-RSP” message, like that of FIG. 13, to the MSS 300 in step 302. Thereafter, in step 303, the S-BS 310 transmits an “I-am-host-of” message, like that of FIG. 15, to the remaining active BSs of the A-BS 1 320 and the A-BS2 330. Upon receiving the “I-am-host-of” message from the S-BS 310, the A-BS1 320 and the A-BS2 330 each check an MSS unique identifier in the “I-am-host-of” message, and transmit, in step 304, an “MSS-info-request” message, like that of FIG. 16, to the S-BS 310 to request information on the corresponding MSS 300 as active BSs for the MSS 300.

Both steps 303 and 304, represented by dotted lines in FIG. 24, are optional and may be omitted. Upon receiving the “MSS-info-request” message, the S-BS 310 transmits, in step 305, an “MSS-info-response” message, like that of FIG. 17, to the A-BS1 320 and the A-BS2 330. Upon receiving the “MSS-info-response” message, the A-BS1 320 and the A-BS2 330 each check the number of network service information elements of the MSS and their TLV values, included in the “MSS-info-response” message, and delete a corresponding service flow of the MSS 300 according to the checking results. Thereafter, in step 306, the A-BS1 320 and the A-BS2 330 each transmit their processing results to the S-BS 310 using an “MSS-info-confirm” message, like that of FIG 18.

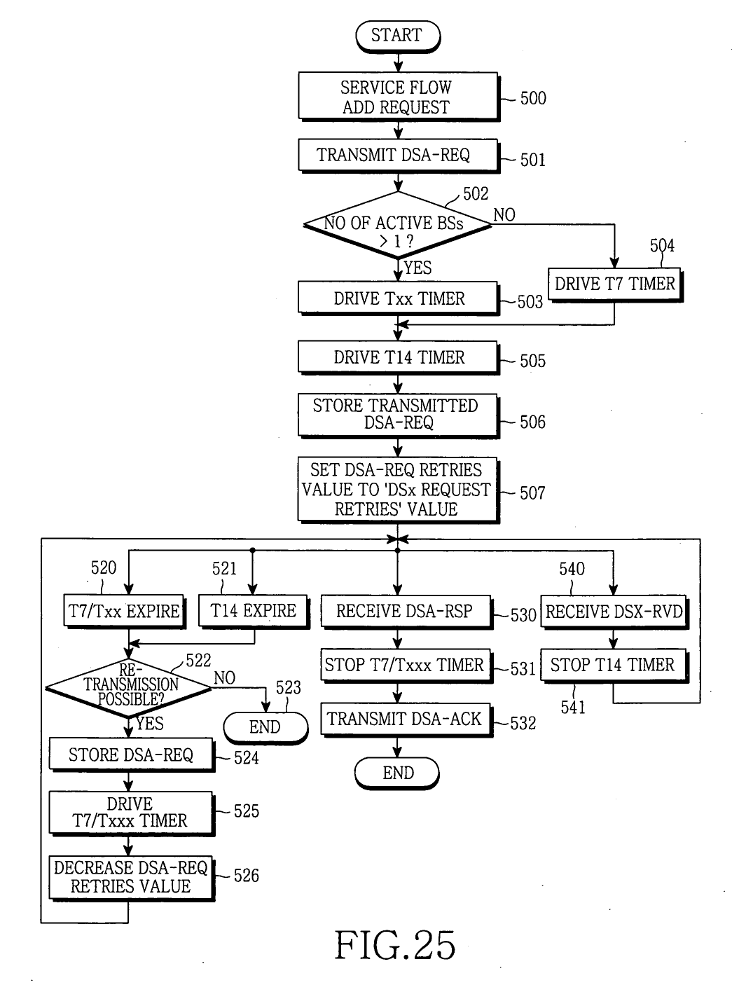

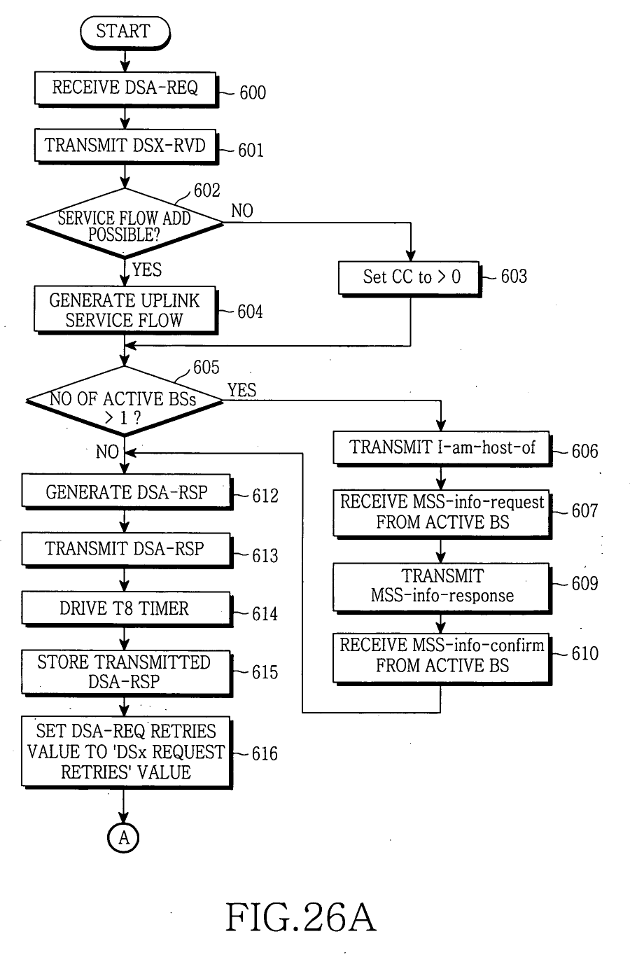

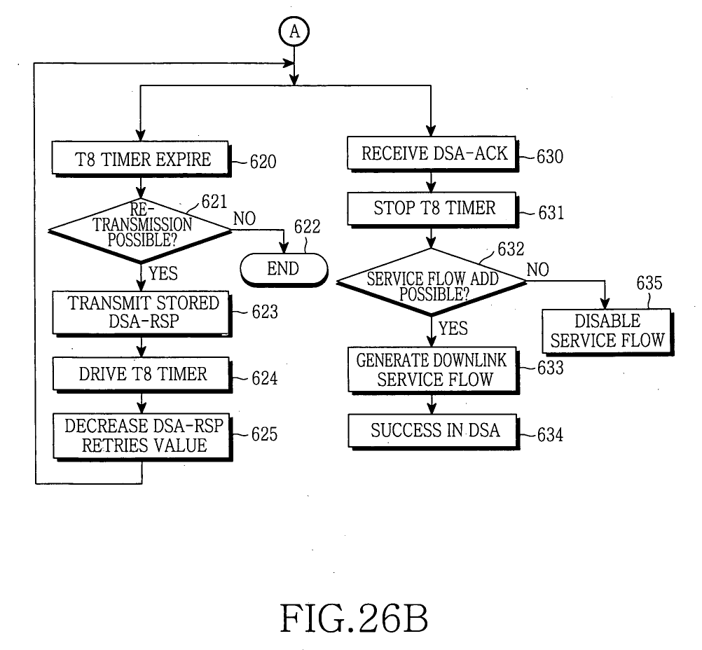

With reference to FIGS. 25, 26A and 26B, a detailed description will now be made of operations of an MSS and an S-BS in a service flow addition method.

FIG. 25 is a flowchart illustrating an operation of an MSS in the procedure of FIG. 14 according to an embodiment of the present invention, and FIGS. 26A and 26B are flowcharts illustrating an operation of an S-BS in the procedure of FIG. 14 according to an embodiment of the present invention. The flowcharts illustrated in FIGS. 25, 26A and 26B include only the parts related to the gist of the present invention.

Referring to FIG. 25, if a service flow addition request is generated in an MSS 100 in step 500, the MSS 100 transmits a DSA-REQ message to an S-BS 110 in step 501. The MSS 100 determines, in step 502, whether the number of active BSs is two or larger. If the number of active BSs is two or larger, the MSS 100 drives a timer Txx in step 503. If the number of active BSs is one, the MSS 100 drives a timer T7 in step 504. The MSS 100 drives a timer T14 in step 505, and stores the transmitted DSA-REQ message in preparation for retransmission in step 506. In step 507, the MSS 100 sets a DSA-REQ Retries value to a DSx Request Retries value.

Thereafter, if the timers T7/Txx and the timer T14 expire in steps 520 and 521, respectively, the MSS 100 determines, in step 522, whether retransmission is possible. If retransmission is not possible, the MSS 100 ends the Dynamic Service Addition operation in step 523. However, if retransmission is possible, the MSS 100 stores a DSA-REQ message in step 524, and drives the timers T7/Txx in step 525.

Thereafter, the MSS 100 decreases the DSA-REQ Retries value in step 526. If the MSS 100 receives a DSA-RSP message from the S-BS in step 530, the MSS 100 stops the timers T7/Txx in step 531, and transmits a DSA-ACK message to the S-BS in step 532, completing the DSA procedure. If the MSS 100 receives a DSX-RVD message from the S-BS in step 540, the MSS 100 stops the timer T14 in step 541, and waits for a DSA-RSP message.

Referring to FIGS. 26A and 26B, if an S-BS 110 receives a DSA-REQ message from an MSS 100 in step 600, the S-BS 110 transmits a DSX-RVD message to the MSS 100 in step 601. The S-BS 110 determines, in step 602, whether service flow addition for the MSS 100 has been completed. If the service flow addition for the MSS 100 has not been completed, the S-BS 110 sets the result in a Confirmation Code (CC) in step 603. The Confirmation Code represents a processing success (CC=‘0’) of the service flow or a processing failure (CC=‘1’) of the service flow. However, if it is determined, in step 602, that the service flow addition for the MSS 100 has been completed, the S-BS 110 generates an uplink service flow in step 604. Herein, the uplink service flow refers to a service flow from the MSS 100 to the S-BS 110, and pairs with a downlink service flow from the S-BS 110 to the MSS 100.

The S-BS 110 determines, in step 605, whether the number of active BSs for the MSS 100 is two or larger. If the number of active BSs for the MSS 100 is two or larger, the S-BS 110 transmits an I-am-host-of message to the remaining active BSs 120 and 130, except the S-BS 110 itself, in step 606. In step 607, the S-BS 110 receives an MSS-info-request response message for generation of a service flow for the MSS 100 from the active BSs 120 and 130 in step 607. In step 609, the S-BS 110 transmits an MSS-info-response message with information on the MSS 100 to the active BSs 120 and 130.

In step 610, the S-BS 110 receives MSS-info-confirm messages from the active BSs 120 and 130. After step 610, or if it is determined in step 605 that the number of active BSs is not larger than 2, the S-BS 110 proceeds to step 612.

The S-BS 110 generates a DSA-RSP message in step 612, and transmits the DSA-RSP message to the MSS 100 in step 613. Thereafter, the S-BS 110 drives a timer T8 in step 614.

The S-BS 110 stores the DSA-RSP message in preparation for retransmission in step 615, and sets a DSA-REQ Retries value to a DSx Request Retries value in step 616. Thereafter, if the timer T8 expires in step 620, the S-BS 110 determines, in step 621, whether retransmission is possible. If it is, the S-BS 110 retransmits the stored DSA-RSP message in step 623, and re-drives the timer T8 in step 624. In step 625, the S-BS 110 decreases a DSA-RSP Retries value and waits for a DSA-ACK message. If the S-BS 110 receives the DSA-ACK message in step 630, the S-BS 110 stops the timer T8 in step 631. Thereafter, the S-BS 110 determines in step 632 whether service flow addition is possible. If service flow addition is possible, the S-BS 110 generates a downlink service flow in step 633, and completes the service flow addition procedure in step 634. However, if service flow addition is not possible, the S-BS 110 disables the service flow in step 635.

As described above, the present invention proposes a service flow update scheme, that includes addition and deletion of service, between an MSS and a BS in an IEEE 802.16e system in which an active BS set is used. With the use of the new service flow management scheme, an MSS having two or more active BSs can collectively update a service flow for the active BSs. In addition, a Connection_settings field defined in the present invention is used for service flow-related parameters to be transmitted to an MSS due to change of a particular service flow in a plurality of active BSs, thereby preventing transmission of duplicate information and increasing transmission efficiency.

While the invention has been shown and described with reference to a certain preferred embodiment thereof, it will be understood by those skilled in the art that various changes in form and details may be made therein without departing from the spirit and scope of the invention as defined by the appended claims.

1. A method for managing a service flow of a mobile subscriber station (MSS) in a serving base station (BS) for a mobile communication system including the serving BS in communication with the MSS through a wireless access channel, and at least one active BS included in an active BS set of the MSS, with the exception of the serving BS, the method comprising:
upon receiving a service flow management request from the MSS, updating a service flow with the MSS;
transmitting the updated service flow to the active BS using a predetermined message; and
upon receiving a response message for the updated service flow from the active BS, transmitting service flow information of each active BS included in the response message to the MSS.

2. The method of claim 1, wherein if the service flow management request from the MSS is a service flow addition request, the serving BS further performs:
adding a service flow with the MSS;
transmitting the added service flow to the active BS using a predetermined message; and
upon receiving a response message for the added service flow from the active BS, transmitting service flow information of each active BS included in the response message to the MSS.

3. The method of claim 1, wherein if the service flow management request from the MSS is a service flow change request, the serving BS further performs:
changing a service flow with the MSS;
transmitting the changed service flow to the active BS using a predetermined message; and
upon receiving a response message for the changed service flow from the active BS, transmitting service flow information of each active BS included in the response message to the MSS.

4. The method of claim 1, wherein if the service flow management request from the MSS is a service flow deletion request, the serving BS further performs:
deleting a service flow with the MSS;
transmitting the deleted service flow to the active BS using a predetermined message; and
upon receiving a response message for the deleted service flow from the active BS, transmitting service flow information of each active BS included in the response message to the MSS.

5. The method of claim 1, further comprising the step of, upon receiving the service flow management request from the MSS, transmitting a predetermined message to the MSS in response to the service flow management request.

6. The method of claim 1, further comprising:
transmitting to the MSS a response message including predetermined information informing the active BS that the serving BS is a serving BS; and
transmitting information on the MSS that has requested update of the service flow, to the active BS.

7. A method for managing a service flow in a mobile subscriber station (MSS) for a mobile communication system including the MSS in communication with a serving base station (BS) though a wireless access channel, and at least one active BS included in an active BS set of the MSS, with the exception of the serving BS, the method comprising:
upon occurrence of a service flow management request, transmitting a predetermined service flow update message to the serving BS; and
receiving a response to the service flow update message from the serving BS, and updating a service flow based on the received response.

8. The method of claim 7, wherein if the service flow management request is a service flow addition request, the MSS further performs:
transmitting a predetermined message for addition of a service flow to the serving BS; and
receiving a response for the added service flow from the serving BS, and adding a new service flow based on the received response.

9. The method of claim 7, wherein if the service flow management request is a service flow change request, the MSS further performs:
transmitting a predetermined message for change of a service flow to the serving BS; and
receiving a response for the changed service flow from the serving BS, and changing a service flow based on the received response.

10. The method of claim 7, wherein if the service flow management request is a service flow deletion request, the MSS further performs:
transmitting a predetermined message for deletion of a service flow to the serving BS; and
receiving a response for the deleted service flow from the serving BS, and deleting a service flow according to the received response.

11. A method for adding a service flow of a mobile subscriber station (MSS) in a serving base station (BS) for a mobile communication system including the serving BS in communication with the MSS through a wireless access channel, and at least one active BS included in an active BS set of the MSS, the method comprising:
upon receiving a service flow addition request from the MSS, adding a service flow identifier (ID);
transmitting the added service flow ID to the active BS using a predetermined message; and
upon receiving a response message with the added service flow ID from the active BS, allocating a new connection ID to the MSS.

12. The method of claim 11, further comprising receiving a dynamic service addition request (DSA-REQ) message when the MSS requests addition of the service flow.

13. The method of claim 11, wherein the active BSs have the same service flow ID and different connection IDs for connections being set up to the MSS.

14. The method of claim 11, further comprising transmitting a dynamic service addition response (DSA-RSP) message to the MSS upon receiving a response message with the added service flow ID from the active BSs.

15. A method for changing a service flow of a mobile subscriber station (MSS) in a serving base station (BS) for a mobile communication system including the serving BS in communication with the MSS through a wireless access channel, and at least one active BS included in an active BS set of the MSS, the method comprising:
upon receiving a service flow change request from the MSS, changing a service flow identifier (ID);
transmitting the changed service flow ID to the active BS using a predetermined message; and
upon receiving a response message with the changed service flow ID from the active BS, transmitting information on the changed service flow to the MSS.

16. The method of claim 15, further comprising receiving a dynamic service change request (DSC-REQ) message when the MSS requests change of the service flow.

17. The method of claim 15, wherein the active BSs have the same service flow ID and different connection IDs for connections being set up to the MSS.

18. The method of claim 15, further comprising transmitting a dynamic service change response (DSC-RSP) message to the MSS upon receiving a response message with the changed service flow ID from the active BSs.

19. A method for deleting a service flow of a mobile subscriber station (MSS) in a serving base station (BS) for a mobile communication system including the serving BS in communication with the MSS through a wireless access channel, and at least one active BS included in an active BS set of the MSS, the method comprising:
upon receiving a service flow deletion request from the MSS, deleting a service flow identifier (ID);
transmitting the deleted service flow ID to the active BS using a predetermined message; and
informing the MSS of deletion of a connection ID.

20. The method of claim 19, further comprising receiving a dynamic service deletion request (DSD-REQ) message when the MSS requests deletion of the service flow.

21. The method of claim 19, wherein the active BSs have the same service flow ID and different connection IDs for connections being set up to the MSS.

22. A method for managing a service flow of a mobile subscriber station (MSS) in a serving base station (BS) for a mobile communication system including the serving BS in communication with the MSS through a wireless access channel, and at least one active BS included in an active BS set of the MSS, the method comprising:
upon receiving a service flow management request from the MSS, allocating a connection identifier (ID) to the MSS according to the service flow; and
transmitting to the MSS the allocated connection ID and a connection ID allocated to the MSS according to the service flow in the at least one active BS exclusive of the serving BS.

23. The method of claim 22, further comprising transmitting a predetermined message indicating necessity of management of the service flow to the at least one active BS exclusive of the serving BS.

24. The method of claim 23, wherein the predetermined message indicating necessity of management of the service flow includes a service flow ID.

25. The method of claim 22, further comprising receiving a predetermined message including a service flow management result from the at least one active BS exclusive of the serving BS.

26. The method of claim 25, wherein the predetermined message including a service flow management result includes a connection ID allocated to the MSS according to the service flow in the at least one active BS exclusive of the serving BS.

27. A method for managing a service flow in a mobile subscriber station (MSS) for a mobile communication system including a serving base station (BS) in communication with the MSS through a wireless access channel, and at least one active BS included in an active BS set of the MSS, with the exception of the serving BS, the method comprising:
upon occurrence of a service flow management request, transmitting a predetermined service flow update request message to the serving BS; and
receiving a response message for the service flow update request message from the serving BS, and updating service flows of active BSs included in the active BS set.
